(19) United States
(12) Patent Application Publication
(10) Pub. No.: US 2008/0166179 A1
(43) Pub. Date: Jul. 10, 2008

(54) LEVER-ARCH TYPE FILE MECHANISM

(76) Inventors: Xi Tao DENG, Chong Qing City (CN); Chun Yuen TO, Hong Kong (HK); Hung Yu CHENG, Hong Kong (HK)

Correspondence Address: OSTROLENK FABER GERB & SOFFEN, 1180 AVENUE OF THE AMERICAS, NEW YORK, NY, 100368403, US

(21) Appl. No.: 11/744,959

(22) Filed: May 7, 2007

(30) Foreign Application Priority Data
Jan. 5, 2007 (EP) 07250033.3

(51) Int. Cl. B42F 13/12

(52) U.S. Cl. 402/70; 402/19

(57) ABSTRACT

A lever-arch type file mechanism (100, 200, 300) is disclosed as including a base (102) two rings secured to and extending upwardly from the base (102) for engaging holes in pieces of paper, each ring including a post (104, 204) fixed to the base (102) and an arch element (106, 206) movable relative to the base (102) and the post (104, 204); a lever (110, 210, 310) operable to move the arch elements (106, 206) relative to the posts (104, 204) between a closed configuration in which the rings are closed and an open configuration in which the rings are open; and the arch elements (106, 206) are joined by an integrally formed bent section (120, 220) which is asymmetrically bent about its mid point.

This invention relates to a device for retaining a stack of hole-punched paper in a file and, in particular such a device comprising a lever-arch type file mechanism.

In most existing lever-arch type file mechanisms, a one-armed lever is provided for pivoting a pair of arch elements relative to a pair of fixed posts to allow pieces of hole-punched paper to be retrieved from or inserted into the file mechanisms, and for closing the posts and arch elements to form a pair of closed rings retain the paper therein. Because of the positioning of the lever, when the ring pairs are open, paper can only be retrieved from or inserted into the pair of fixed posts, but no paper can be retrieved from or inserted into the pair of pivotable arch elements.

In some other existing lever-arch type file mechanisms, a two-armed lever is provided for pivoting a pair of arch elements. However, in most such mechanisms, one of the lever arms is designated as the “OPENING” arm, to be pivoted downwardly to open the pairs of arch elements, and the other lever arm is designated as the “CLOSING” arm, to be pivoted downwardly to close the pairs of arch elements. Thus, the “OPENING” arm cannot be operated to close the ring pairs; neither can the “CLOSING” arm be operated to open the ring pairs.

It is thus an object of the present invention to provide a lever-arch type file mechanism in which the aforesaid shortcomings are mitigated, or at least to provide a useful alternative to the public.

According to a first aspect of the present invention, there is provided a lever-arch type file mechanism including a base; at least two rings secured to and extending upwardly from the base for engaging holes in at least a piece of paper, each said ring including a post member fixed to said base and an arch member movable relative to said base and said post member; a lever operable to move said arch members relative to said post members between a closed configuration in which said rings are closed and an open configuration in which said rings are open; characterized in that said lever includes a first and a second arm members both operable to selectively open and close said rings.

According to a second aspect of the present invention, there is provided a lever-arch type file mechanism including a base; at least two rings secured to and extending upwardly from the base for engaging holes in at least a piece of paper, each said ring including a post member fixed to said base and an arch member movable relative to said base and said post member; a lever operable to move said arch members relative to said post members between a closed configuration in which said rings are closed and an open configuration in which said rings are open; wherein said arch members are joined by an integrally formed bent section; characterized in that said bent section is asymmetrically bent about its mid point.

According to a third aspect of the present invention, there is provided a lever-arch type file mechanism including a base; at least two rings secured to and extending upwardly from the base for engaging holes in at least a piece of paper, each said ring including a post member fixed to said base and an arch member movable relative to said base and said post member; a lever operable to move said arch members relative to said post members between a closed configuration in which said rings are closed and an open configuration in which said rings are open; wherein said arch members are joined by an integrally formed bent section; and wherein a biasing means acts on said bent section to bias said arch members towards the open configuration; characterized in that said biasing means is out of contact with the lowest part of said bent section.

According to a fourth aspect of the present invention, there is provided a lever-arch type file mechanism including a base; at least two rings secured to and extending upwardly from the base for engaging holes in at least a piece of paper, each said ring including a post member fixed to said base and an arch member movable relative to said base and said post member; a lever operable to move said arch members relative to said post members between a closed configuration in which said rings are closed and an open configuration in which said rings are open; wherein said arch members are joined by an integrally formed bent section; and wherein a biasing means acts on said bent section to bias said arch members towards the open configuration; characterized in that said biasing means is asymmetrically disposed about the mid point of said bent section.

According to a fifth aspect of the present invention, there is provided a lever-arch type file mechanism including a base; at least two rings secured to and extending upwardly from the base for engaging holes in at least a piece of paper, each said ring including a post member fixed to said base and an arch member movable relative to said base and said post member; a lever with at least one arm member operable to move said arch members relative to said post members between a closed configuration in which said rings are closed and an open configuration in which said rings are open; characterized in that an extremity of said arm member extends beyond the ring closer thereto by a horizontal distance of within substantially 40 mm.

According to a sixth aspect of the present invention, there is provided a lever-arch type file mechanism including a base; at least two rings secured to and extending upwardly from the base for engaging holes in at least a piece of paper, each said ring including a post member fixed to said base and an arch member movable relative to said base and said post member; a lever with at least one arm member operable to move said arch members relative to said post members between a closed configuration in which said rings are closed and an open configuration in which said rings are open; wherein said arm member is pivotable between a lower position and an upper position to selectively open or close said rings; characterized in that an extremity of said arm member is above the bottom of said base by at least substantially 6 mm when said arm member is in said lower position.

According to a seventh aspect of the present invention, there is provided a lever-arch type file mechanism including a base; at least two rings secured to and extending upwardly from the base for engaging holes in at least a piece of paper, each said ring including a post member fixed to said base and an arch member movable relative to said base and said post member; a lever with at least one arm member pivotable between two stable positions to move said arch members relative to said post members between a closed configuration in which said rings are closed and an open configuration in which said rings are open; characterized in that said lever is pivotable by within substantially 45° between said two stable positions.

According to an eighth aspect of the present invention, there is provided a lever-arch type file mechanism including a base; at least two rings secured to and extending upwardly from the base for engaging holes in at least a piece of paper, each said ring including a post member fixed to said base and an arch member movable relative to said base and said post member; a lever operable to move said arch members relative to said post members between a closed configuration in which said rings are closed and an open configuration in which said rings are open; wherein said arch members are joined by an integrally formed bent section; wherein an actuator carried by said lever moves on and along said bent section between two stable positions to open and close said rings; characterized in that the horizontal distance traveled by said actuator between said two stable positions is within substantially 8.5 mm.

According to a ninth aspect of the present invention, there is provided a lever-arch type file mechanism including a base; at least two rings secured to and extending upwardly from the base for engaging holes in at least a piece of paper, each said ring including a post member fixed to said base and an arch member movable relative to said base and said post member; a lever with at least one arm member operable to move said arch members relative to said post members between a closed configuration in which said rings are closed and an open configuration in which said rings are open; wherein said arch members are joined by an integrally formed bent section; characterized in that the arm member is formed by moulding or formed of a sheet material.

According to a tenth aspect of the present invention, there is provided a lever-arch type file mechanism including a base; at least two rings secured to and extending upwardly from the base for engaging holes in at least a piece of paper, each said ring including a post member fixed to said base and an member movable relative to said base and said post member; a lever pivotally mounted to a wall member extending generally upwardly from said base, and operable to move said arch members relative to said post members between a closed configuration in which said rings are closed and an open configuration in which said rings are open; wherein said arch members are joined by an integrally formed bent section; and wherein a biasing means acts on said bent section to bias said arch members towards the open configuration; characterized in that said biasing means is asymmetrically disposed about the point at which the lever is pivotally mounted to said wall member.

According to an eleventh aspect of the present invention, there is provided a lever-arch type file mechanism including a base; at least two rings secured to and extending upwardly from the base for engaging holes in at least a piece of paper, each said ring including a post member fixed to said base and an arch member movable relative to said base and said post member; a lever with at least one arm operable to move said arch members relative to said post members between a closed configuration in which said rings are closed and an open configuration in which said rings are open; wherein said arm member is pivotable between a lower position and an upper position to selectively open or close said rings; characterized in that when said arm member is in said upper position, said arch members are receivable into and removable from said holes of said piece of paper.

According to a twelfth aspect of the present invention, there is provided a lever-arch type file mechanism including a base; at least two rings secured to and extending upwardly from the base for engaging holes in at least a piece of paper, each said ring including a post member fixed to said base and an arch member movable relative to said base and said post member; a lever operable to move said arch members relative to said post members between a closed configuration in which said rings are closed and an open configuration in which said rings are open; wherein said lever includes a first and a second arm members; characterized in that at least part of said first arm member is of a colour different from that of at least part of said second arm member.

Embodiments of lever-arch type file mechanisms according to the present invention will now be described, by way of examples only, with reference to the accompanying drawings, in which:

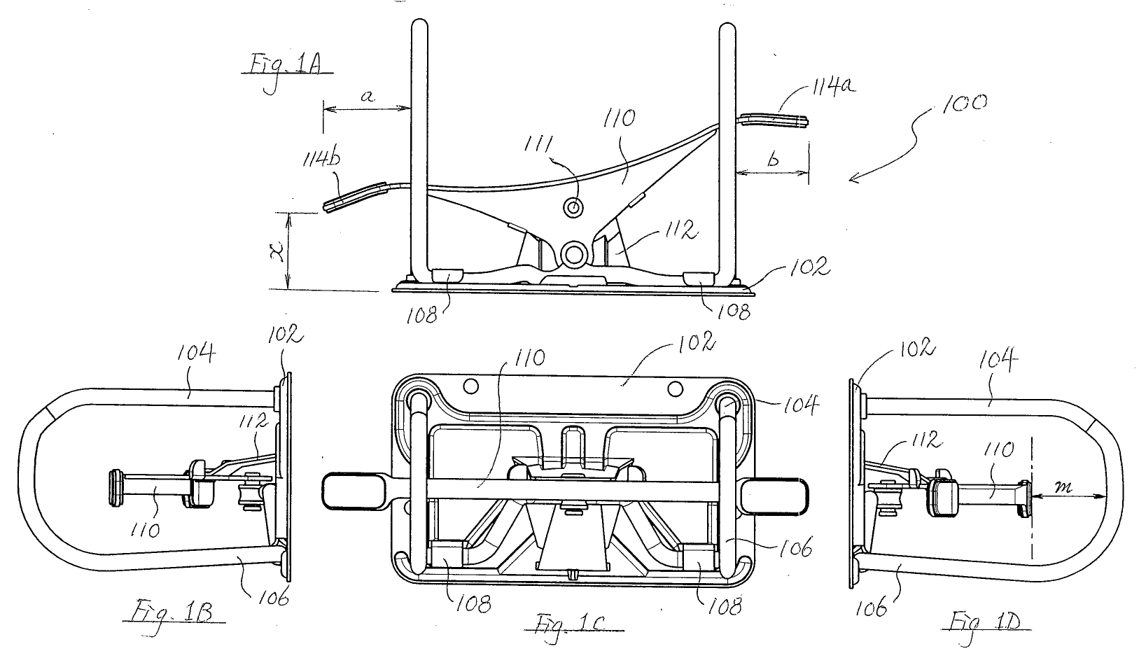

FIG. 1A is a front view of a lever-arch type file mechanism according to a first embodiment of the present invention in a closed configuration;

FIG. 1B is a side view of the file mechanism shown in FIG. 1A;

FIG. 1C is a top view of the file mechanism shown in FIG. 1A;

FIG. 1D is another side view of the file mechanism shown 1A;

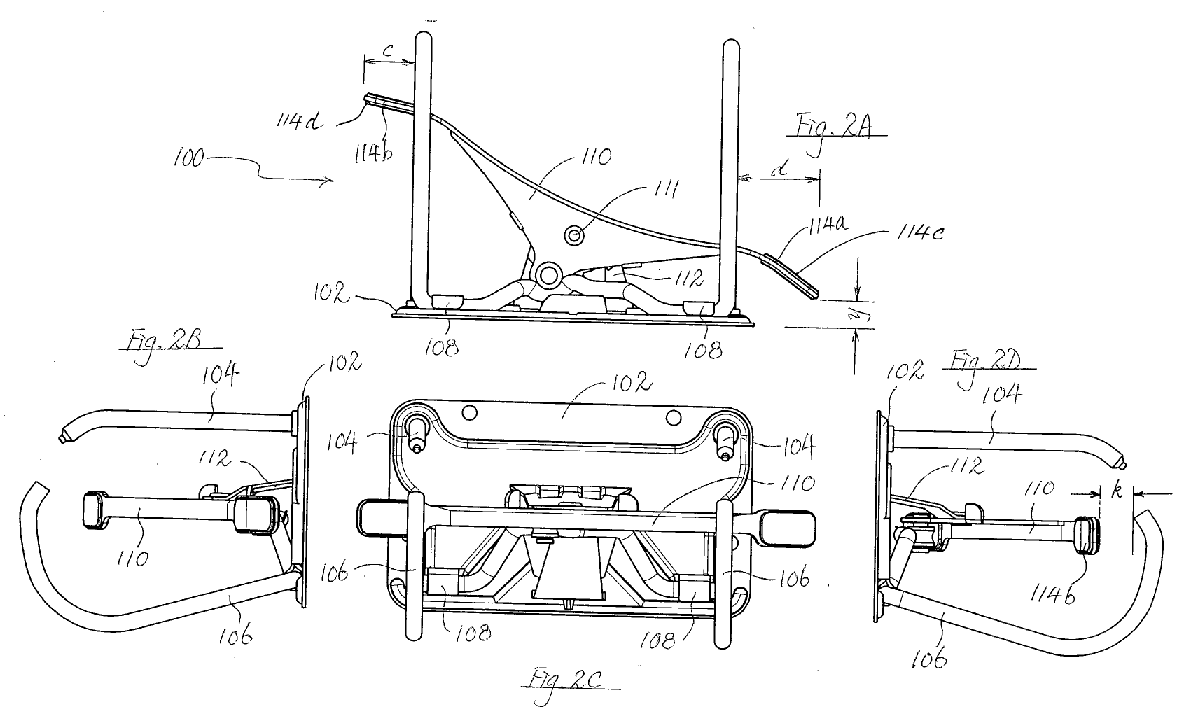

FIG. 2A is a front view of the file mechanism shown in FIG. 1A in an open configuration;

FIG. 2B is a side view of the file mechanism shown in FIG. 2A;

FIG. 2C is a top view of the file mechanism shown in FIG. 2A;

FIG. 2D is a further side view of the file mechanism shown in FIG. 2A;

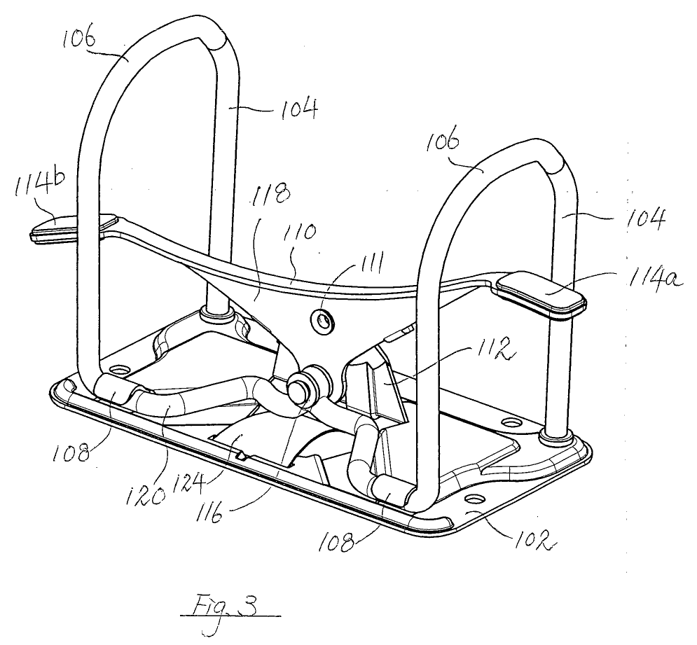

FIG. 3 is a front perspective view of the file mechanism shown IA;

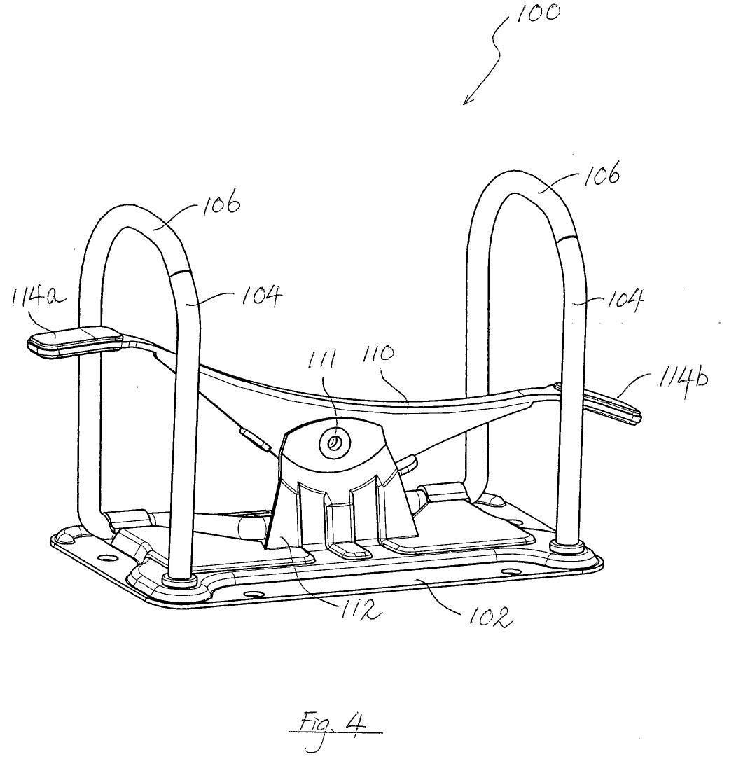

FIG. 4 is a back perspective view of the file mechanism shown 1A;

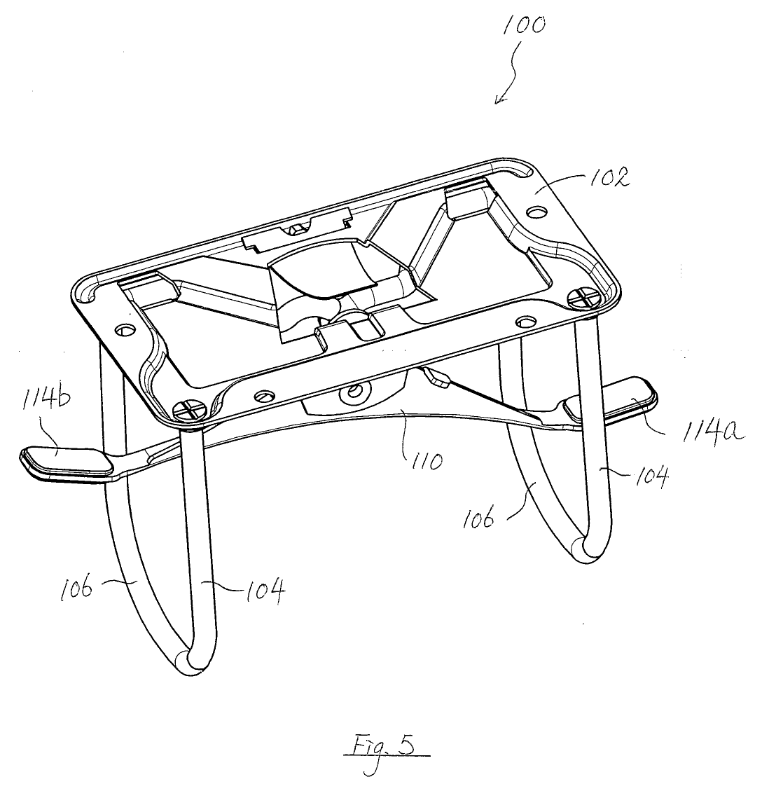

FIG. 5 is a bottom perspective view of the file mechanism shown 1A;

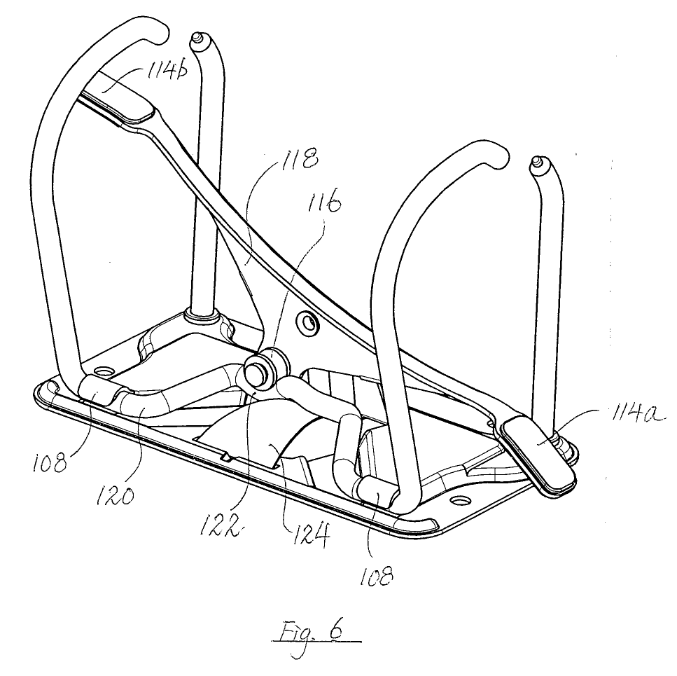

FIG. 6 is a front perspective view of the file mechanism shown 2A;

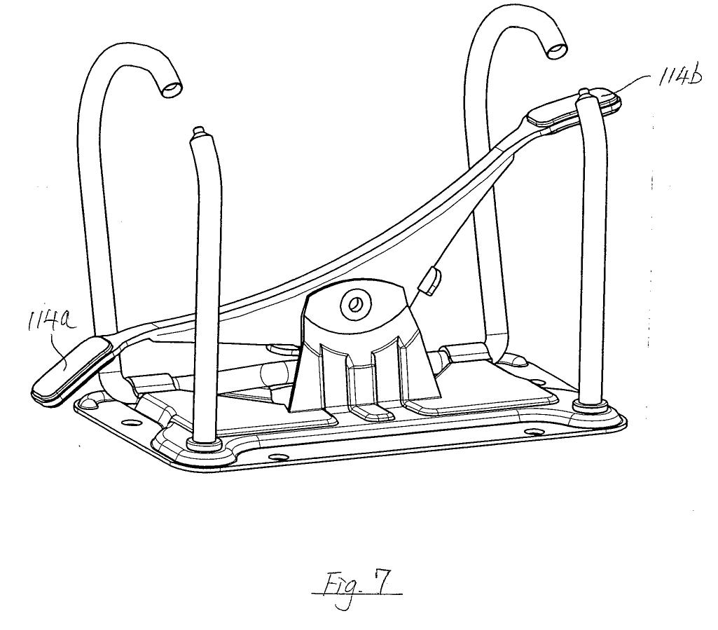

FIG. 7 is a back perspective view of the file mechanism shown 2A;

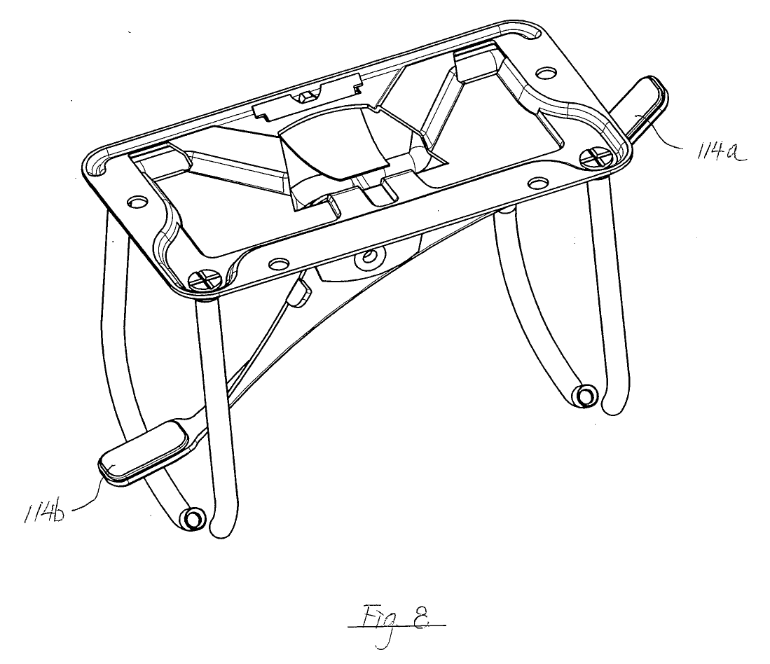

FIG. 8 is a bottom back perspective view of the file mechanism shown 2A;

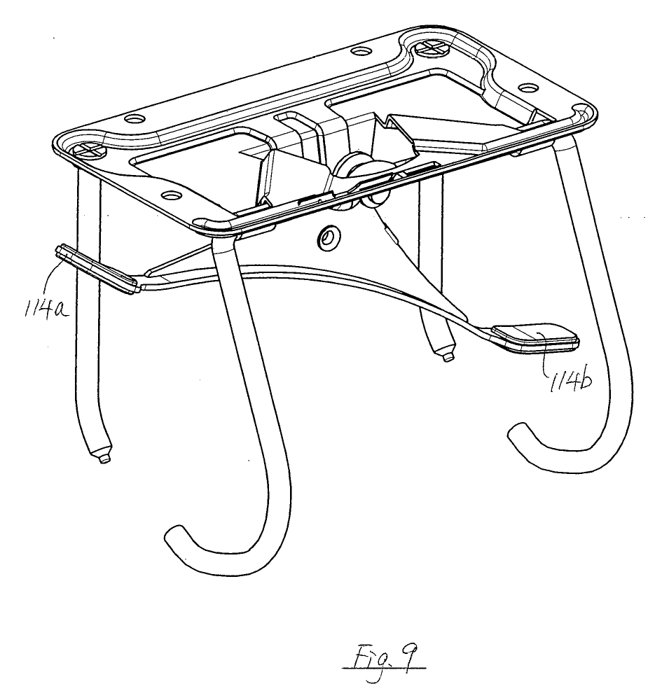

FIG. 9 is a bottom front perspective view of the file mechanism shown 2A, with the bent portion removed;

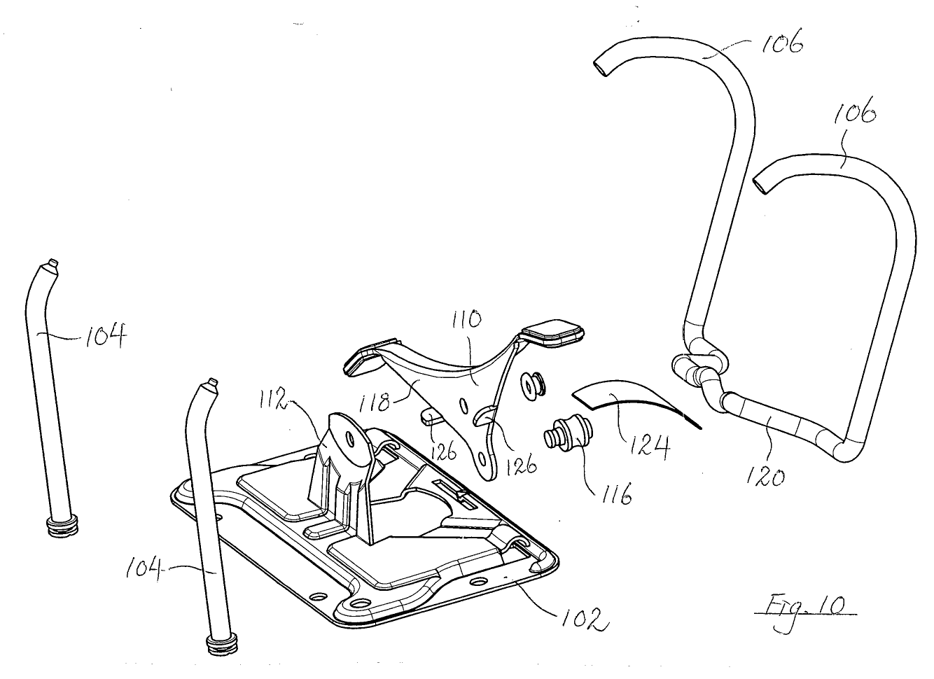

FIG. 10 is an exploded view of the file mechanism shown in FIG. 1A;

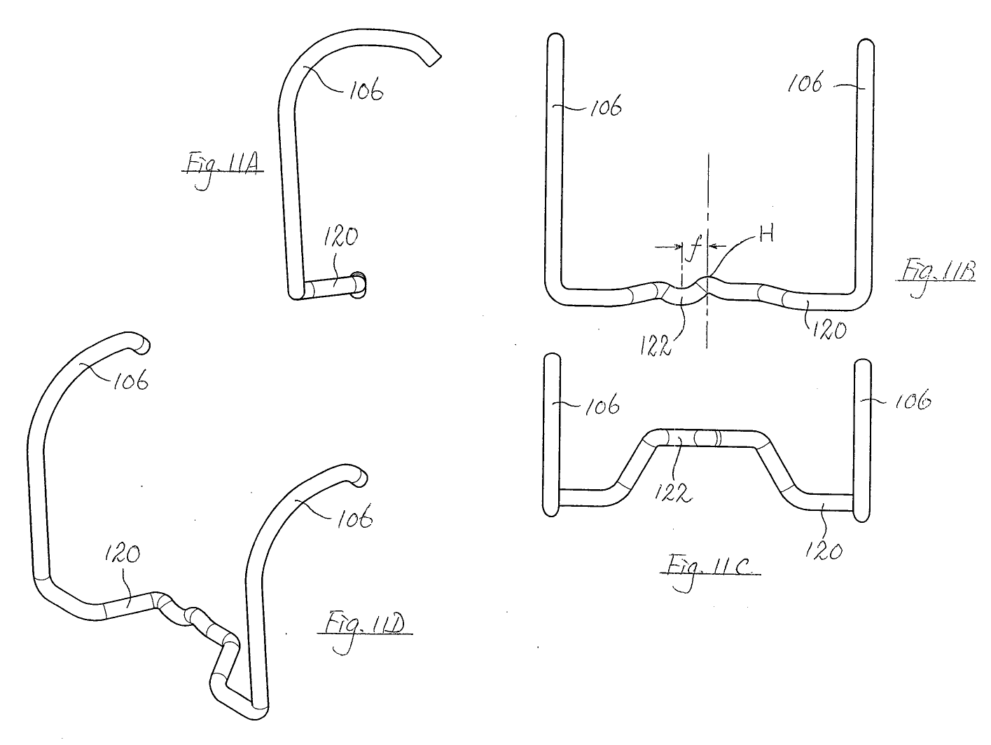

FIG. 11A is a side view of the bent portion of the file mechanism shown in FIG. 1A;

FIG. 11B is a front view of the bent portion shown in FIG. 11A;

FIG. 11C is a top view of the bent portion shown in FIG. 11A;

FIG. 11D is a top perspective view of the bent portion shown in FIG. 11A;

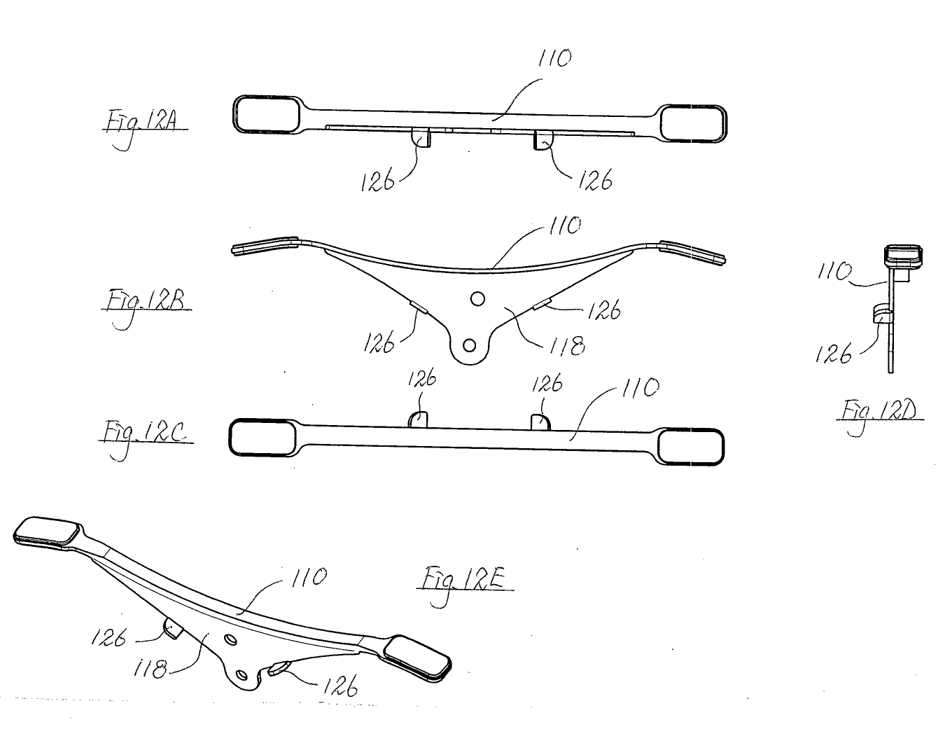

FIG. 12A is a bottom view of the lever of the file mechanism shown in FIG. 1A;

FIG. 12B is a front view of the lever shown in FIG. 12A;

FIG. 12C is a top view of the lever shown in FIG. 12A;

FIG. 12D is a side view of the lever shown in FIG. 12A;

FIG. 12E is a top perspective view of the lever shown in FIG. 12A;

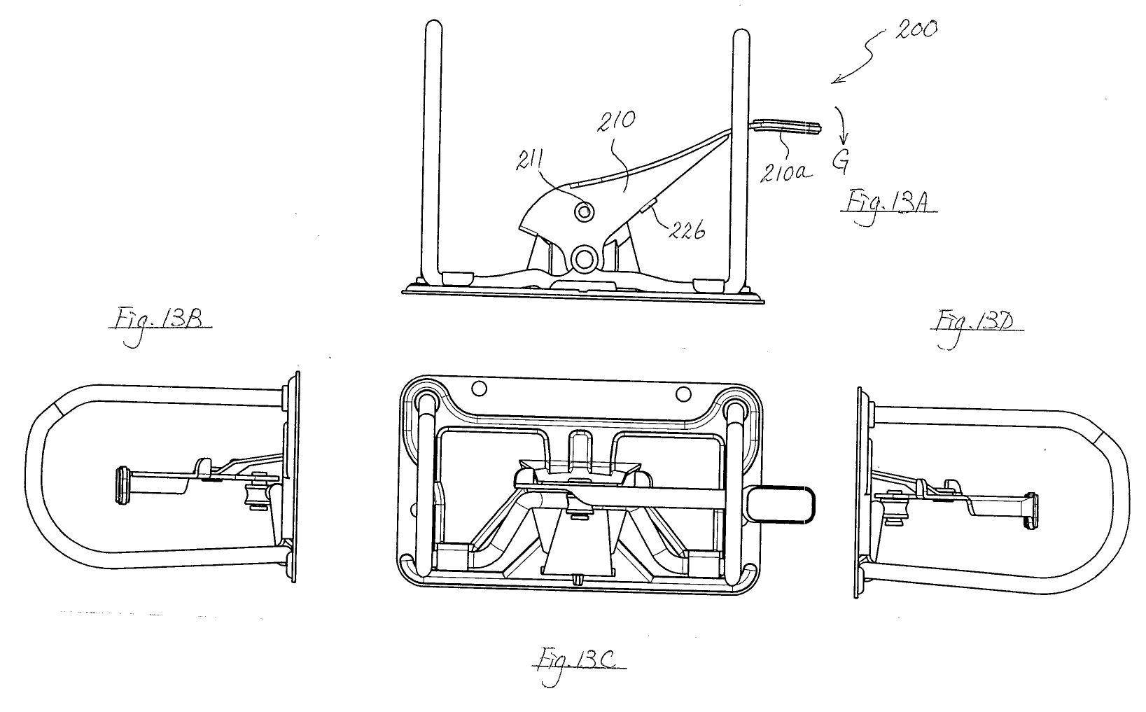

FIG. 13A is a front view of a lever-arch type file mechanism according to a second embodiment of the present invention in a closed configuration;

FIG. 13B is a side view of the file mechanism shown in FIG. 13A;

FIG. 13C is a top view of the file mechanism shown in FIG. 13A;

FIG. 13D is another side view of the file mechanism shown 13A;

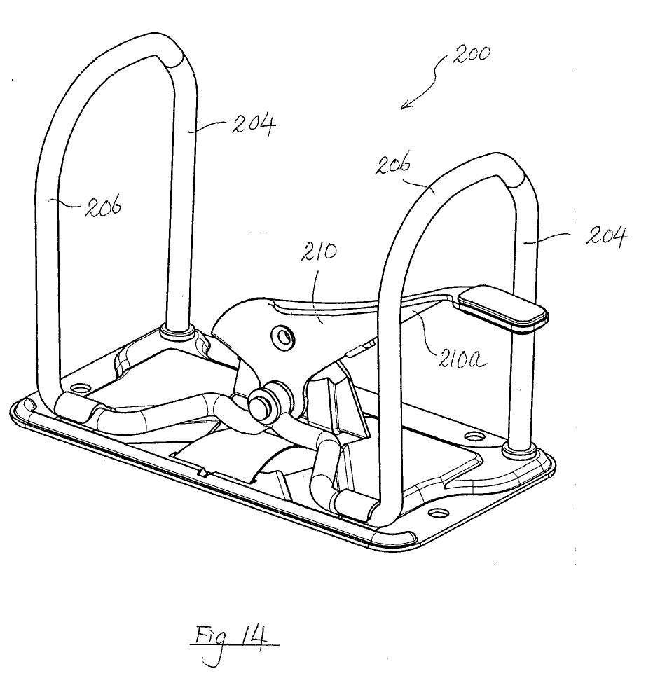

FIG. 14 is a front perspective view of the file mechanism shown in FIG. 13A;

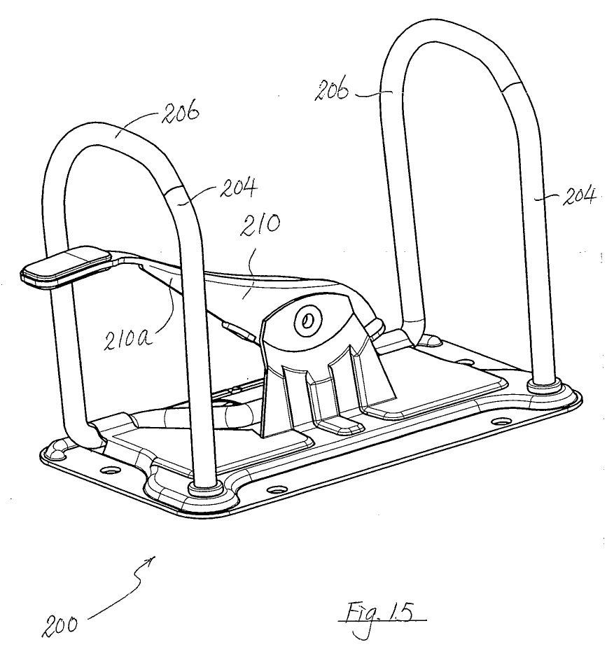

FIG. 15 is a back perspective view of the file mechanism shown in FIG. 13A;

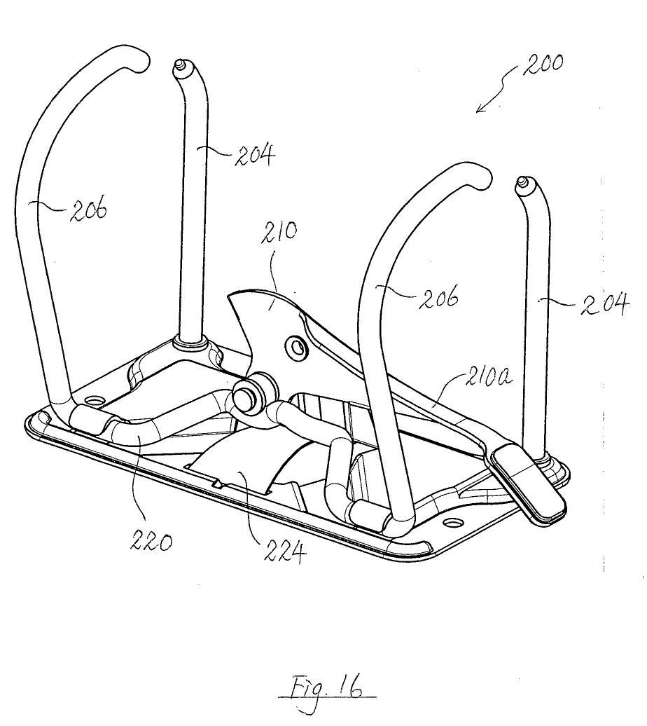

FIG. 16 is a front perspective view of the file mechanism shown in FIG. 13A in an open configuration;

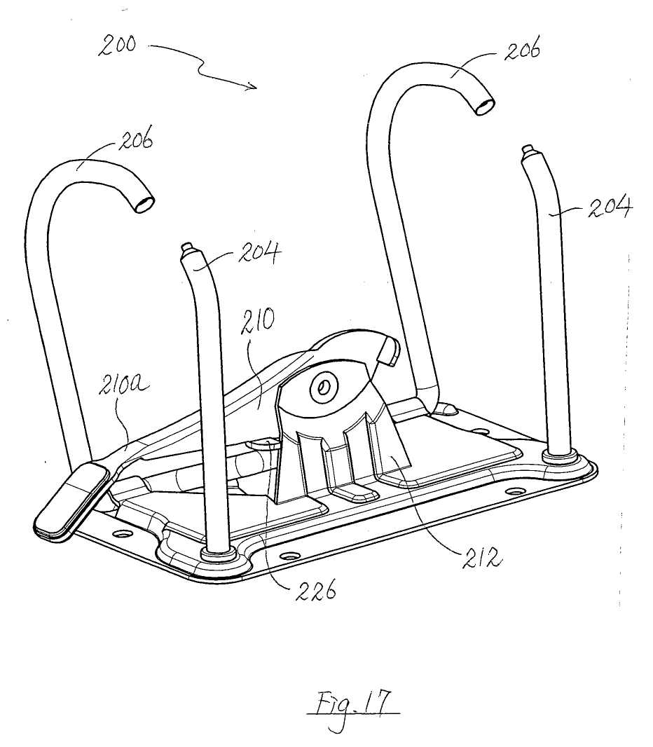

FIG. 17 is a back perspective view of the file mechanism shown in FIG. 16;

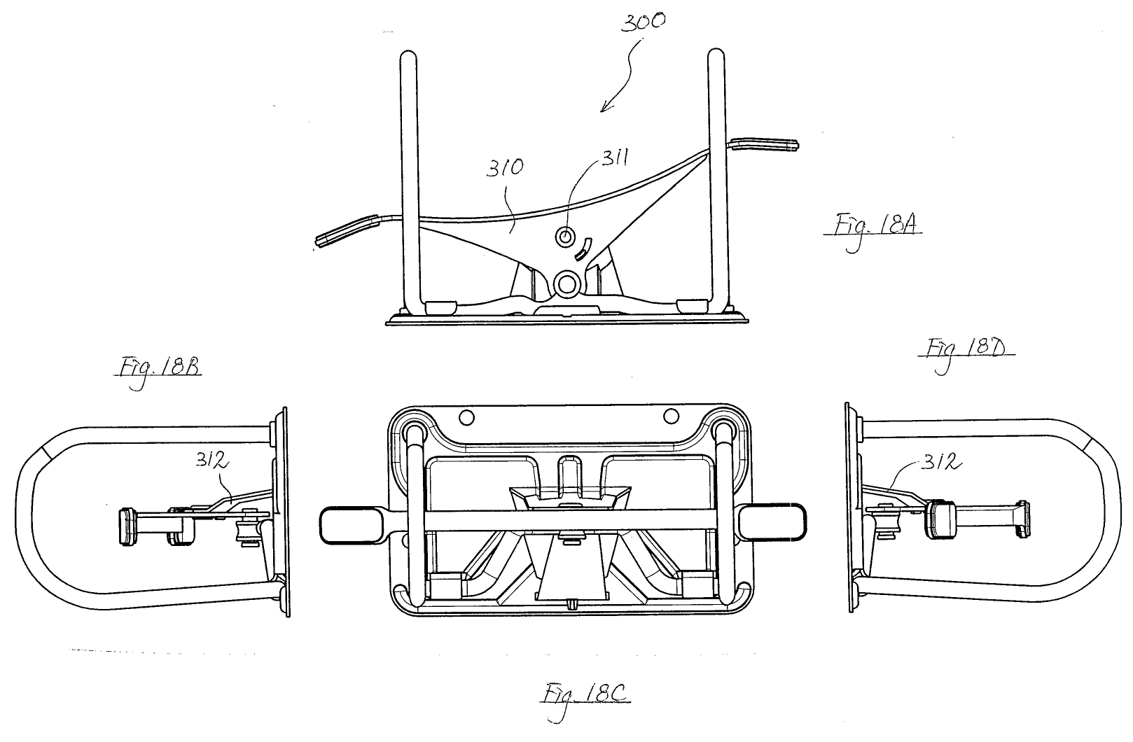

FIG. 18A is a front view of a lever-arch type file mechanism according to a third embodiment of the present invention in a closed configuration;

FIG. 18B is a side view of the file mechanism shown in FIG. 18A;

FIG. 18C is a top view of the file mechanism shown in FIG. 18A;

FIG. 18D is another side view of the file mechanism shown 18A;

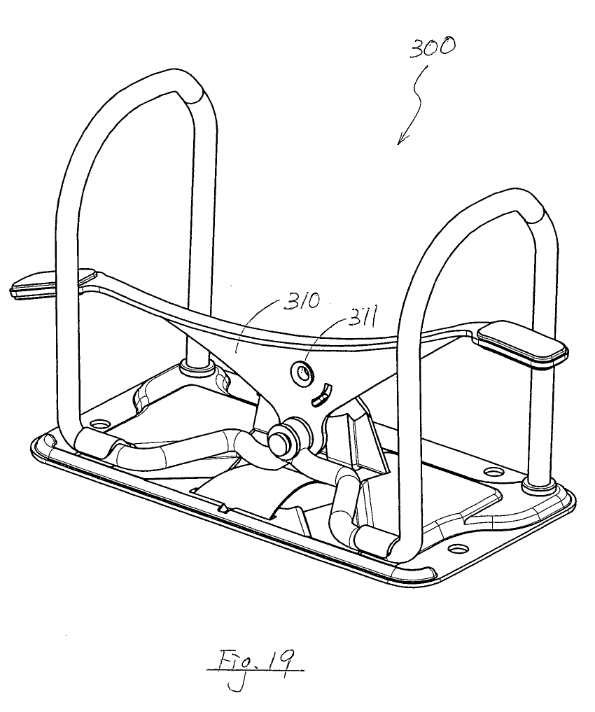

FIG. 19 is a front perspective view of the file mechanism shown in FIG. 18A;

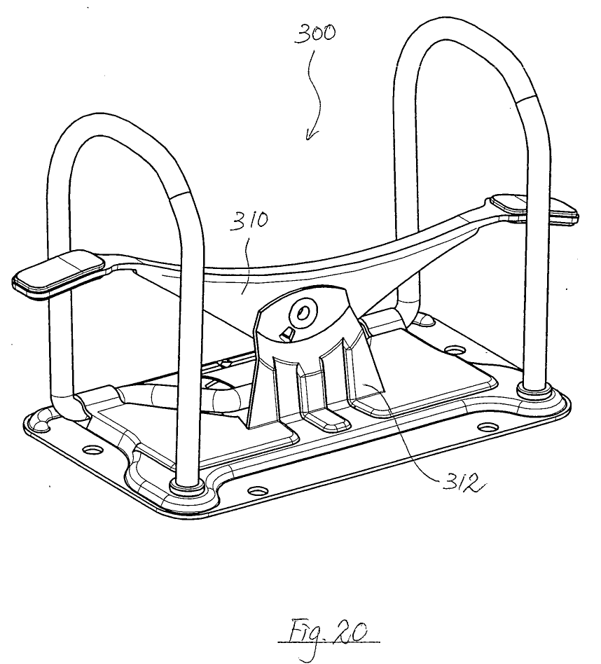

FIG. 20 is a back perspective view of the file mechanism shown in FIG. 18A;

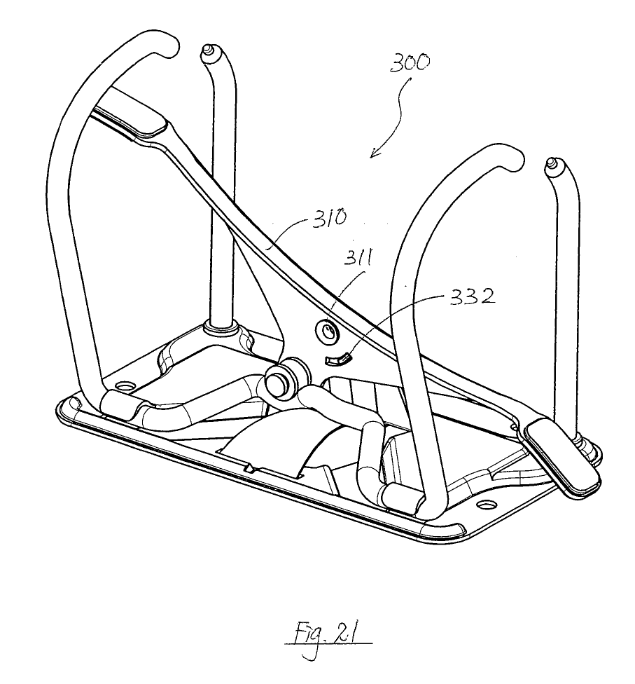

FIG. 21 is a front perspective view of the file mechanism shown in FIG. 18A in an open configuration;

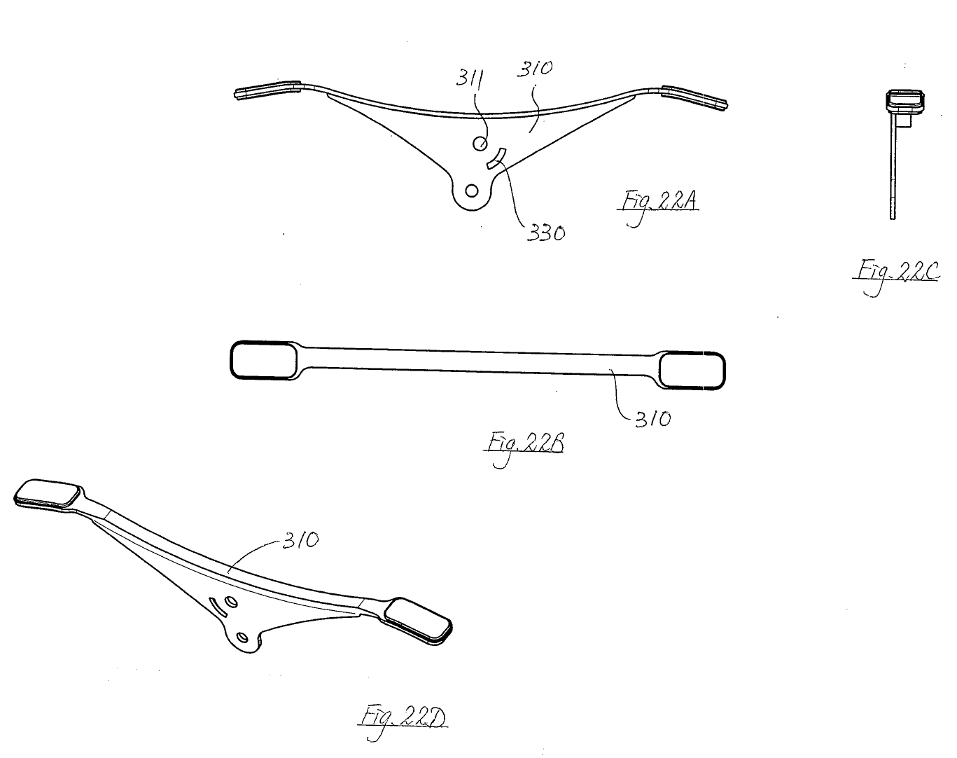

FIG. 22A is a front view of the lever of the file mechanism shown in FIG. 18A;

FIG. 22B is a top view of the lever shown in FIG. 22A;

FIG. 22C is a side view of the lever shown in FIG. 22A; and

FIG. 22D is a top perspective view of the lever shown in FIG. 22A.

FIGS. 1A to 1D and 3 to 5 show a lever-arch type file mechanism according to a first embodiment of the present invention, generally designated as 100, in a closed configuration, and FIGS. 2A to 2D, and 6 to 9 show the file mechanism 100 in an open configuration.

The file mechanism 100 has a base 102 integrally formed of a sheet of metal, e.g. stainless steel. Two spaced apart posts 104 are fixedly secured to the base 102. Two correspondingly positioned arch elements 106 are engaged with the base 102 by a pair of tabs 108 for pivotal movement between the position shown in FIGS. 1A to 1D and 3 to 5 in which the respective upper open ends of the posts 104 and arch elements 106 mate with each other to form two closed rings for retaining a stack of hole-punched paper, and the position shown in FIGS. 2A to 2D and 6 to 9 in which the upper ends of the posts 104 and arch elements 106 are out of contact with each other, such that the rings are open, for allowing pieces of hole-punched paper to be retrieved from or inserted into the rings.

A two-armed lever 110 is pivotally mounted at a pivot point 111 to a wall 112 extending generally upwardly from the base 102. The wall 112 is cut and stamped out of the same sheet of metal forming the base 102. The lever 110 has two generally oppositely extending arms 114a, 114b which are operable to pivot the lever 110 about the pivot point 111 to selectively open or close the rings formed by the posts 104 and arch elements 106. Each of the free end of the arms 114a, 114b is fixed with a plastics resilient cover 114c, 114d for enhancing the safety and comfort of use. The covers 114c, 114d are of different colours, e.g. one may be red and the other green.

In particular, by comparing FIGS. 3 and 6, it can be seen that downward pivoting of the lever arm 114a or upward pivoting of the lever arm 114b will cause an actuating roller 116 fixed to a lower end of a body 118 of the lever 110 to roll, from an upper stable position on a bent portion 120 integrally formed with an joining lower ends of the arch elements 106, on and along the bent portion 120 until it is stably received within a trough portion 122 (as shown in FIG. 6), whereupon a spring leaf 124 acting on and biasing the bent portion 120 causes the arch elements 106 to pivot away from the posts 104 about a pivoting line joining the tabs 108. On the other hand, downwardly pivoting the lever arm 114b or upwardly pivoting the lever arm 114a will cause the roller 116 to roll away from the lower stable position in the trough portion 120 along the bent portion 120 back to the upper stable position shown in FIG. 3 in which the arch elements 106 are caused to pivot back to the position shown in FIG. 3 to mate with the posts 104 to form two closed rings.

In order to ensure that both of the arms 114a, 114b can be pivoted upwardly and downwardly to open and close the rings, it is designed such that the distance x (see. FIG. 1A) between the extremity of the lever arm 114b and the bottom of the base 102 when the lever arm 114b is in its lowermost position is at least 6mm, and the distance y (see FIG. 2A) between the extremity of the lever arm 114a and the bottom of the base 102 when the lever arm 114a is in its lowermost position is also at least 6 mm. This will ensure that a user can put his/her finger into the space between the respective arm 11 4a, 11 4b and the bottom of the base to lift up the arm 114a, 114b, as desired.

It is found in practice that, in order to allow pieces of hole-punched paper to be retrieved from and inserted into the arch elements 106 when the arch elements 106 are pivoted open from the arch elements 104, the horizontal distance (see a, b, c, and d in FIGS. 1A and 2A) between the extremity of the arms 114a, 114b and the respective closer rings should not be more than 40 mm.

It is also found in practice that, to assist in achieving this function, the angle of rotation of the lever 110 required for moving the rings between the closed and open configurations should not be more than 45°. It is also found that, and as shown in FIG. 2D, when the rings are in the open configuration, the vertical distance k between the upper arm 114b and the free end of the arch element 106 closer to it has to be at least 8 mm, and when the rings are in the closed configuration, the vertical distance m (see FIG. 1D) between the upper arm 114a and the arch element 106 closer to it also has to be at least 8 mm.

By way of such an arrangement, when the posts 104 and the arch elements 106 are in the open configuration, in which the arm 114b is in its upper position, the arch elements 106 are receivable into and removable from holes of said piece of paper, as desired.

As shown in FIGS. 10 and 11, In order to limit the angle of rotation of the lever 110 relative to the base 102, on each side of the body 118 of the lever 110 is provided an extension 126 adapted to abut the wall 112 during rotational movement of the lever 100, as can be seen in FIGS. 1A and 2A. The arms 114a, 114b are formed by moulding of a metal, e.g. stainless steel, or formed of a sheet of metal material, e.g. stainless steel.

In order to ensure that the arch elements 106 can exhibit sufficient pivotal movement relative to the posts 104 and the base 102 to sufficiently open or close the rings, the shape of the bent portion 120 has to be specially designed. In particular, as shown in FIGS. 11A to 11D, the bent portion 120 is asymmetrically bent, and thus shaped, about its mid point which is also the highest point (H) in the portion 120, as shown clearly in FIG. 11B. It can be seen that the slope at which the portion 120 descends from the highest point H along the portion 120 rightward is less steep than the slope at which the portion 120 descends from the highest point H along the portion 120 leftward. As discussed above, downward pivoting of the lever arm 114a or upward pivoting of the lever arm 114b will cause the roller 116 fixed to the lever 110 to roll away from the mid point H of the bent portion 120 along the steeper slope of the bent portion 120 until the roller 116 is stably received within the trough portion 122, so as to open the rings. The horizontal distance f traveled by the roller between the upper stable position (H) and the lower stable position in the trough portion 122 to open and/or close the rings is within 8.5 mm.

Because of the asymmetrical shape of the bent portion 120, the positioning of the leaf spring 124 is also changed. In particular, the leaf spring 124 is asymmetrically disposed about the mid point H of the bent portion 120. The leaf spring 124 is generally trapezoidal in shape with two generally parallel sides, of which one is shorter than another. It can be shown, e.g. in FIGS. 1C and 2C, that the shorter side abuts, acts on and effects a biasing force on an underside of the bent portion 120. As the mid point H of the bent portion 120 lies on the same transverse vertical plane as the pivot point 111 about which the lever 110 pivots, the leaf spring 124 is also asymmetrically disposed about the pivot point 111.

In order to allow sufficient pivoting movement of the arch elements 106 relative to the posts 104, the shorter side of the leaf spring 124 is out of contact with the lowest point of the trough portion 122 of the bent portion 120, but supports and effects biasing force on the underside of the bent portion 120 aside of the mid point H of the bent portion 120, and on the side away from the trough portion 122, as more clearly shown in FIG. 6. This allows the lowest point of the trough portion 122 to be closer to the bottom of the base 102 when the rings are closed.

A second embodiment of a lever-arch type file mechanism according to the present invention, generally designated as 200, is shown in FIGS. 13A to 17. A major difference between this file mechanism 200 and the file mechanism 100 discussed above is that a lever 210 of the file mechanism 200 has only one operating arm 210a which is movable to selectively open or close rings formed by posts 204 and arch elements 206. In particular, the arm 210a is pivotable about a pivot point 211 in the direction indicated by the arrow G (see FIG. 13A) to the position shown in FIG. 16, which allows a leaf spring 224 which acts on an underside of a bent portion 220 integrally formed with and joining the arch elements 206 to effect an upward biasing force to pivot the arch elements 206 away from the posts 204 to open the rings. An extension 226 on an underside of the lever 210 is provided to limit the extent of downward pivotal movement of the lever 210, as shown in FIG. 17, in which the extension 226 abuts a side of an upstanding wall 212 to which the lever 210 is pivotally mounted, to stop further downward rotation of the lever 210. Upward pivotal movement of the arm 210 will force down the bent portion 220 to pivot the arch elements 206 back to mating engagement with the posts 204 to close the rings.

A third embodiment of a lever-arch type file mechanism according to the present invention, generally designated as 300, is shown in FIGS. 18A to 22D. This file mechanism is structurally similar to the file mechanism 100 discussed above, with the major difference between the mechanism for limiting the extent of pivotal movement of lever 310 in the file mechanism 300. As shown more clearly in FIGS. 22A to 22D, the lever 310 has a curved slot 330, which is in the form of an arc with its centre being the pivot point 311 about which the lever 310 pivots about an upstanding wall 312. A pin 332 fixedly secured to the wall 312 extends from a major surface of the wall 312 and is received within and movable relative to the slot 330 of the lever 310. Such an arrangement thus limits the maximum extent of rotation of the lever 310 relative to the wall 312 to within 45°, as discussed above.

It should be understood that the above only illustrates examples whereby the present invention may be carried out, and that various modifications and/or alterations may be made thereto without departing from the spirit of the invention.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

1. A lever-arch type file mechanism including:
a base;
at least two rings secured to and extending upwardly from the base for engaging holes in at least a piece of paper, each said ring including a post member fixed to said base and an arch member movable relative to said base and said post member;
a lever operable to move said arch members relative to said post members between a closed configuration in which said rings are closed and an open configuration in which said rings are open;
characterized in that said lever includes a first and a second arm members both operable to selectively open and close said rings.

2. A mechanism according to claim 1 further characterized in that said first arm member is pivotable upwardly to open said rings and pivotable downwardly to close said rings and said second arm member is pivotable downwardly to open said rings and pivotable upwardly to close said rings.

3. A lever-arch type file mechanism including:
a base;
at least two rings secured to and extending upwardly from the base for engaging holes in at least a piece of paper, each said ring including a post member fixed to said base and an arch member movable relative to said base and said post member;
a lever operable to move said arch members relative to said post members between a closed configuration in which said rings are closed and an open configuration in which said rings are open;
wherein said arch members are joined by an integrally formed bent section;
characterized in that said bent section is asymmetrically bent about its mid point.

4. A mechanism according to claim 3 further characterized in that said bent section descends away from its mid point along its length on two sides along two paths with different slopes.

5. A mechanism according to claim 4 further characterized in that said lever is engaged with an actuating part which is movable on and along said bent section to selectively open and close said rings, wherein said actuating part is adapted to move away from adjacent the mid point of said bent section along its length along the path with a steeper slope to open said rings.

6. A lever-arch type file mechanism including:
a base;
at least two rings secured to and extending upwardly from the base for engaging holes in at least a piece of paper, each said ring including a post member fixed to said base and an arch member movable relative to said base and said post member;
a lever operable to move said arch members relative to said post members between a closed configuration in which said rings are closed and an open configuration in which said rings are open;
wherein said arch members are joined by an integrally formed bent section; and
wherein a biasing means acts on said bent section to bias said second arch members towards the open configuration;
characterized in that said biasing means is out of contact with the lowest part of said bent section.

7. A mechanism according to claim 6 further characterized in that said biasing means is a spring leaf.

8. A mechanism according to claim 7 further characterized in that said spring leaf is generally trapezoidal in shape.

9. A mechanism according to claim 8 further characterized in that said spring leaf has two generally parallel sides, of which a shorter one abuts said bent section.

10. A lever-arch type file mechanism including:
a base;
at least two rings secured to and extending upwardly from the base for engaging holes in at least a piece of paper, each said ring including a post member fixed to said base and an arch member movable relative to said base and said post member;
a lever operable to move said arch members relative to said post members between a closed configuration in which said rings are closed and an open configuration in which said rings are open;
wherein said arch members are joined by an integrally formed bent section; and
wherein a biasing means acts on said bent section to bias said arch members towards the open configuration;
characterized in that said biasing means is asymmetrically disposed about the mid point of said bent section.

11. A mechanism according to claim 10 further characterized in that said biasing means is a spring leaf.

12. A mechanism according to claim 11 further characterized in that said spring leaf is generally trapezoidal in shape.

13. A mechanism according to claim 12 further characterized in that said spring leaf has two generally parallel sides, of which a shorter one abuts said bent section.

14. A lever-arch type file mechanism including:
a base;
at least two rings secured to and extending upwardly from the base for engaging holes in at least a piece of paper, each said ring including a post member fixed to said base and an arch member movable relative to said base and said post member;
a lever with at least one arm member operable to move said arch members relative to said post members between a closed configuration in which said rings are closed and an open configuration in which said rings are open;
characterized in that an extremity of said arm member extends beyond the ring closer thereto by a horizontal distance of within substantially 40 mm.

15. A mechanism according to claim 14 further characterized in that said extremity of said arm member extends beyond the ring closer thereto by a horizontal distance of within substantially 40 mm when said rings are in the closed configuration.

16. A mechanism according to claim 14 further characterized in that said lever has two arm members, the respective extremity of which extends beyond the ring closer respectively thereto by a horizontal distance of within substantially 40 mm.

17. A lever-arch type file mechanism including:
a base;
at least two rings secured to and extending upwardly from the base for engaging holes in at least a piece of paper, each said ring including a post member fixed to said base and an arch member movable relative to said base and said post member;
a lever with at least one arm member operable to move said arch members relative to said post members between a closed configuration in which said rings are closed and an open configuration in which said rings are open;
wherein said arm member is pivotable between a lower position and an upper position to selectively open or close said rings;
characterized in that an extremity of said arm member is above the bottom of said base by at least substantially 6 mm when said arm member is in said lower position.

18. A mechanism according to claim 17 further characterized in that said lever has two arm members, and the respective extremity of said arm members is above the bottom of said base by at least substantially 6 mm when said respective arm member is in its said lower position.

19. A lever-arch type file mechanism including:
a base;
at least two rings secured to and extending upwardly from the base for engaging holes in at least a piece of paper, each said ring including a post member fixed to said base and an arch member movable relative to said base and said post member;
a lever with at least one arm member pivotable between two stable positions to move said second arch members relative to said first arch members between a closed configuration in which said rings are closed and an open configuration in which said rings are open;
characterized in that said lever is pivotable by within substantially 45° between said two stable positions.

20. A mechanism according to claim 19 further including means for limiting the extent of pivotal movement of said lever between said two stable positions.

21. A mechanism according to claim 20 further characterized in that said lever has a body with two side edges each having a stopping member.

22. A mechanism according to claim 21 further characterized in including a wall member extending generally upwardly from said base, and wherein said stopping members are movable with said lever to abut said wall member to limit the extent of pivotal movement of said lever.

23. A mechanism according to claim 20 further characterized in that said lever has a body formed with a curved slot.

24. A mechanism according to claim 23 further characterized in including a wall member extending generally upwardly from said base, and wherein a pin extending from a major surface of said wall member is received within the curved slot of said lever.

25. A lever-arch type file mechanism including:
a base;
at least two rings secured to and extending upwardly from the base for engaging holes in at least a piece of paper, each said ring including a post member fixed to said base and an arch member movable relative to said base and said post member;
a lever operable to move said arch members relative to said post members between a closed configuration in which said rings are closed and an open configuration in which said rings are open;
wherein said arch members are joined by an integrally formed bent section;
wherein an actuator carried by said lever moves on and along said bent section between two stable positions to open and close said rings;
characterized in that the horizontal distance traveled by said actuator between said two stable positions is within substantially 8.5 mm.

26. A lever-arch type file mechanism including:
a base;
at least two rings secured to and extending upwardly from the base for engaging holes in at least a piece of paper, each said ring including a post member fixed to said base and an arch member movable relative to said base and said post member;
a lever with at least one arm member operable to move said arch members relative to said post members between a closed configuration in which said rings are closed and an open configuration in which said rings are open;
wherein said arch members are joined by an integrally formed bent section;
characterized in that the arm member is formed by moulding or formed of a sheet material.

27. A lever-arch type file mechanism including:
a base;
at least two rings secured to and extending upwardly from the base for engaging holes in at least a piece of paper, each said ring including a post member fixed to said base and an arch member movable relative to said base and said post member;
a lever pivotally mounted to a wall member extending generally upwardly from said base, and operable to move said second arch members relative to said post members between a closed configuration in which said rings are closed and an open configuration in which said rings are open;
wherein said arch members are joined by an integrally formed bent section; and
wherein a biasing means acts on said bent section to bias said arch members towards the open configuration;
characterized in that said biasing means is asymmetrically disposed about the point at which the lever is pivotally mounted to said wall member.

28. A mechanism according to claim 28 further characterized in that said biasing means is a spring leaf.

29. A mechanism according to claim 29 further characterized in that said spring leaf is generally trapezoidal in shape.

30. A lever-arch type file mechanism including:
a base;
at least two rings secured to and extending upwardly from the base for engaging holes in at least a piece of paper, each said ring including a post member fixed to said base and an arch member movable relative to said base and said post member;
a lever with at least one arm operable to move said arch members relative to said post members between a closed configuration in which said rings are closed and an open configuration in which said rings are open;
wherein said arm member is pivotable between a lower position and an upper position to selectively open or close said rings;
characterized in that when said arm member is in said upper position, said arch members are receivable into and removable from said holes of said piece of paper.

31. A mechanism according to claim 30 further characterized in that when said arm member is in said upper position and when said rings are in said open configuration, the vertical distance between said arm member and the arch member closer thereto is at least 8mm.

32. A lever-arch type file mechanism including:
a base;
at least two rings secured to and extending upwardly from the base for engaging holes in at least a piece of paper, each said ring including a post member fixed to said base and an arch member movable relative to said base and said post member;
a lever operable to move said arch members relative to said post members between a closed configuration in which said rings are closed and an open configuration in which said rings are open;
wherein said lever includes a first and a second arm members;
characterized in that at least part of said first arm member is of a colour different from that of at least part of said second arm member.
